(19) United States
(12) Patent Application Publication
(10) Pub. No.: US 2026/0302046 A1
(43) Pub. Date: Oct. 1, 2026

(54) MAGNETIC COMPONENT

(71) Applicant: Delta Electronics, Inc., Taoyuan City (TW)

(72) Inventors: Chi-Yu Lee, Taoyuan City (TW); Meng-Hsien Lin, Taoyuan City (TW)

(21) Appl. No.: 19/219,849

(22) Filed: May 27, 2025

(30) Foreign Application Priority Data
Mar. 26, 2025 (CN) 202510366127.3

(51) Int. Cl. H01F 27/28; H01F 27/30; H01F 38/14

(52) U.S. Cl. CPC H01F 27/2847; H01F 27/306; H01F 38/14

(57) ABSTRACT

A magnetic component includes a magnetic plate frame, a magnetic element and a winding. The magnetic plate frame includes a central portion. The magnetic element is disposed on the magnetic plate frame and includes a plurality of magnetic plates. The plurality of magnetic plates are disposed around the central portion and separated from one another. The central post is disposed on one side of the magnetic plate main body adjacent to the central portion. The central posts of the plurality of magnetic plates are separated from each other. The first outer post is disposed on one side of the magnetic plate main body away from the central portion. The channel is disposed between the central portion and the first outer post. The winding is disposed in the channels of the plurality of magnetic plates.

### CROSS-REFERENCE TO RELATED APPLICATION

This application claims the priority to China Patent Application No. 202510366127.3, filed on Mar. 26, 2025, the entirety of which is hereby incorporated by reference.

### FIELD OF THE INVENTION

The present disclosure relates to wireless charging, and more particularly to a magnetic component.

### BACKGROUND OF THE INVENTION

In the field of wireless charging, the size of the coil within the magnetic component must be increased to enhance the inductive performance of the magnetic component according to the increasing of the output power and the increasing of sensing distance required in industrial applications. However, the magnetic plate of the conventional magnetic component is integrally formed in to one piece. The output power of the power transmission coil is excessively concentrated. The requirements on the receiving terminal receiving the output power is enhanced. The compatibility of the receiving terminal with traditional magnetic components is affected. Moreover, the magnetic plate of the conventional magnetic components is integrally formed in to one piece, and the quantity and assembly method of the conventional magnetic components are relatively rigid. Consequently, the flexibility is reduced and the manufacturing cost is increased.

Therefore, there is a need of providing a magnetic component to obviate the drawbacks encountered from the prior arts.

### SUMMARY OF THE INVENTION

The present disclosure provides a magnetic component. The magnetic component of the present disclosure includes four magnetic plates. The four magnetic plates are separated from one another. Namely, the magnetic component of the present disclosure can induce a uniform magnetic field to evenly output power. The magnetic plate of the receiving terminal is enabled to sense a uniform magnetic field, and the winding of the receiving terminal is enabled to generate induced power. Consequently, the loading of the transmitting winding is reduced and the adaptability of the magnetic assembly of the present disclosure is improved. Additionally, the assembly method can be adjusted according to installation requirements. The convenience of the magnetic assembly is enhanced. The size and the cost of the magnetic assembly are also reduced. Moreover, the current output of the winding can be evenly distributed. Moreover, since each magnetic plate of the magnetic element includes a central post and an outer post, the inductance of the magnetic component is increased.

In accordance with an aspect of the present disclosure, a magnetic component is provided. The magnetic component includes a magnetic plate frame, a magnetic element and a winding. The magnetic plate frame includes a central portion. The magnetic element is disposed on the magnetic plate frame and includes a plurality of magnetic plates. The plurality of magnetic plates are disposed around the central portion. The plurality of magnetic plates are separated from one another. Each of the plurality of magnetic plates includes a magnetic plate main body, a central post, a first outer post and a channel. The central post is disposed on one side of the magnetic plate main body adjacent to the central portion. The central posts of the plurality of magnetic plates are separated from each other. The first outer post is disposed on one side of the magnetic plate main body away from the central portion. The channel is defined by a surface of the magnetic plate main body, the central post and the first outer post collaboratively and formed between the central post and the first outer post. The winding is disposed in the channels of the plurality of magnetic plates.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic view illustrating a magnetic component according to the present disclosure;

FIG. 2 is a schematic exploded view illustrating the magnetic component of FIG. 1; and

FIG. 3 is a schematic view illustrating the magnetic component of FIG. 1 taken along another viewpoint.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

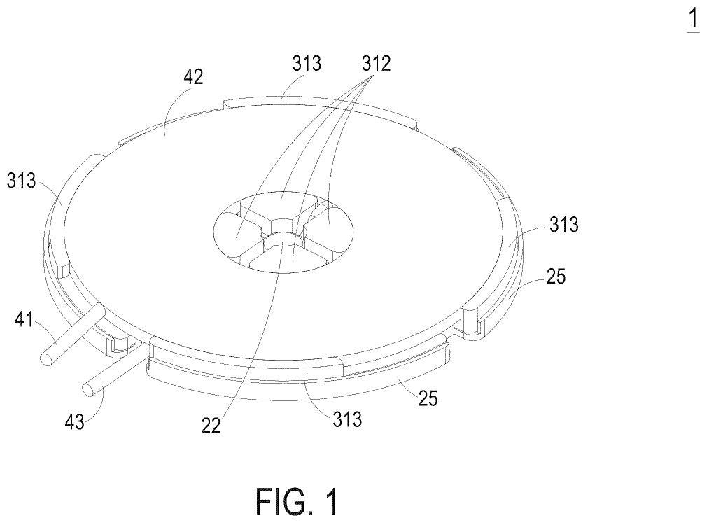

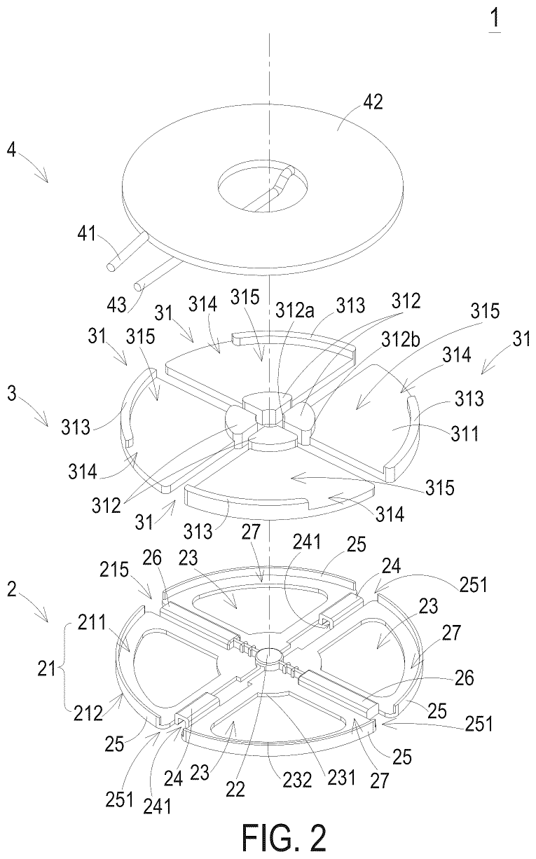

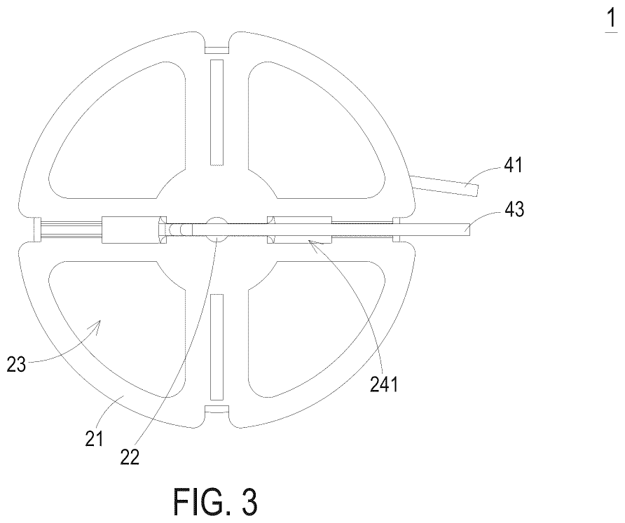

FIG. 1 is a schematic view illustrating a magnetic component according to the present disclosure. FIG. 2 is a schematic exploded view illustrating the magnetic component of FIG. 1. FIG. 3 is a schematic view illustrating the magnetic component of FIG. 1 taken along another viewpoint. As shown in FIGS. 1 to 3, the magnetic component 1 of the present disclosure includes a magnetic plate frame 2, a magnetic element 3 and a winding 4. The magnetic plate frame 2 is a disc-shaped structure and includes a magnetic plate frame main body 21, a central portion 22, four holes 23, two protrusions 24, four second outer posts 25, two fixing portions 26 and four magnetic plate frame grooves 27.

The magnetic plate frame main body 21 includes a first surface 211 and a second surface 212. The first surface 211 and the second surface 212 of the magnetic plate frame main body 21 are opposite to each other. The central portion 22 is a cylindrical structure. The central portion 22 is disposed at the center of the first surface 211 of the magnetic plate frame main body 21. The central portion 22 is protruded from the first surface 211 away from the second surface 212 of the magnetic plate frame main body 21. The four holes 23 run through the first surface 211 and the second surface 212 of the magnetic plate frame main body 21. The four holes 23 are disposed around the central portion 22 in sequence. In this embodiment, each hole 23 is a sector-ring shape and includes a first arc 231 and a second arc 232. The first arc 231 of each hole 23 is disposed adjacent to the central portion 22. The second arc 232 is disposed away from the central portion 22 than the first arc 231. The length of the second arc 232 is greater than the length of the first arc 231. Each protrusion 24 is protruded from the first surface 211 of the magnetic plate frame main body 21. Each protrusion 24 is extended radially. Each protrusion 24 is located between corresponding two holes 23 and includes a recess 241. The opening direction of the recess 241 is from the first surface 211 facing toward the second surface 212. The opening of the recess 241 faces away from the magnetic element 3. In this embodiment, the two protrusions 24 are located on two opposite sides of the central portion 22.

Four second outer posts 25 are disposed around the periphery of the magnetic plate frame main body 21. Each second outer post 25 is extended from the first surface 211 of the magnetic plate frame main body 21 away from the second surface 212. A gap 251 is formed between two adjacent second outer posts 25. Each fixing portion 26 is disposed on the first surface 211 of the magnetic plate frame main body 21. One side of each fixing portion 26 is connected with the central portion 22 and extended from the central portion 22 toward the magnetic plate frame main body 21 radially. In this embodiment, the two fixing portions 26 are disposed on two opposite sides of the central portion 22. The two fixing portions 26 are staggered with the two protrusions 24 and disposed around the central portion 22. Two sides of each second outer post 25 is adjacent to one protrusion 24 and one fixing portion 26, respectively. As shown in FIG. 2, each second outer post 25, the protrusion 24 adjacent to the second outer post 25, the fixing portion 26 adjacent to the second outer post 25, a portion of the first surface 211 of the magnetic plate frame main body 21 form a magnetic plate frame groove 27 collaboratively. In this embodiment, the magnetic component 1 includes four magnetic plate frame grooves 27.

The magnetic element 3 is served as a transmitting magnetic plate and disposed on the first surface 211 of the magnetic plate frame main body 21 of the magnetic plate frame 2. The magnetic element 3 includes four magnetic plates 31 disposed around the central portion 22 in sequence. The four magnetic plates 31 are separated from one another. Each magnetic plate 31 is disposed in the corresponding magnetic plate frame groove 27 and covers the corresponding hole 23. Each magnetic plate 31 includes a magnetic plate main body 311, a central post 312, a first outer post 313, a mounting slot 314 and a channel 315. The magnetic plate main body 311 is a sector-ring structure and disposed within the corresponding magnetic plate frame groove 27. Consequently, the magnetic plate main body 311 is limited by the protrusion 24 and the fixing portion 26. The thickness of the magnetic plate main body 311 is equal to the height of the corresponding second outer post 25 of the magnetic plate frame main body 21. The central post 312 is disposed on the side of the magnetic plate main body 311 adjacent to the central portion 22. The central posts 312 of the plurality of magnetic plates 31 are separated from each other. The central post 312 of each magnetic plate 31 is a sector-ring structure and includes an inner ring portion 312a and an outer ring portion 312b. The inner ring portion 312a is concaved from the side of the central post 312 adjacent to the central portion 22. The outer ring portion 312b is disposed between the inner ring portion 312a and the first outer post 313. The first outer post 313 is located on the side of the magnetic plate main body 311 away from the central portion 22. The first outer post 313 is extended from the first surface 211 of the magnetic plate frame main body 21 away from the second surface 212. The first outer post 313 is disposed around a portion of periphery of the magnetic plate main body 311 away from the central post 312. The mounting slot 314 is disposed on the side of the magnetic plate main body 311 away from the central portion 22. The mounting slot 314 is adjacent to the corresponding first outer post 313. The channel 315 is defined by the surface of the corresponding magnetic plate main body 311 away from the magnetic plate frame main body 21, the outer ring portion 312b of the central post 312 and one side of the first outer post 313 collaboratively and formed between the central post 312 and the first outer post 313. In this embodiment, the magnetic plate main body 311, the central post 312 and the first outer post 313 of each magnetic plate 31 of the magnetic element 3 are integrally formed into one piece. In this embodiment, the height of each protrusion 24 is equal to the height of the magnetic plate main body 311.

The winding 4 is served as a transmission coil to output the power. Consequently, the magnetic element 3 serving as the transmitting magnetic plate induces a uniform magnetic field. The winding 4 includes an input terminal 41, a winding main body 42 and an output terminal 43. The input terminal 41 of the winding 4 is disposed in one of the mounting slots 314 and protruded from the magnetic component 1 through the mounting slot 314. One end of the winding main body 42 of the winding 4 is connected with the input terminal 41. The other end of the winding main body 42 of the winding 4 is connected with the output terminal 43. The winding main body 42 is disposed on the magnetic element 3 and passes through the channel 315 of the four magnetic plates 31. The thickness of the winding main body 42 is equal to the height of the first outer post 313 of the magnetic plate 31. The output terminal 43 of the winding 4 passes between the central posts 312 of the two magnetic plates 31, the central portion 22 and the recess 241 of one of the protrusions 24. Consequently, the output terminal 43 is extended to the exterior of the magnetic component 1 through the recess 241. The output direction of the winding 4 is limited by the protrusion 24 of the magnetic plate frame 2.

As mentioned above, the magnetic component of the present disclosure includes four magnetic plates. The four magnetic plates are separated from one another. Namely, the magnetic component of the present disclosure can induce a uniform magnetic field to evenly output power. The magnetic plate of the receiving terminal is enabled to sense a uniform magnetic field, and the winding of the receiving terminal is enabled to generate induced power. Consequently, the loading of the transmitting winding is reduced and the adaptability of the magnetic assembly of the present disclosure is improved. Additionally, the assembly method can be adjusted according to installation requirements. The convenience of the magnetic assembly is enhanced. The size and the cost of the magnetic assembly are also reduced. Moreover, the current output of the winding can be evenly distributed. Moreover, since each magnetic plate of the magnetic element includes a central post and an outer post, the inductance of the magnetic component is increased.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetic component, comprising:
a magnetic plate frame comprising a central portion;
a magnetic element disposed on the magnetic plate frame and comprising a plurality of magnetic plates, wherein the plurality of magnetic plates are disposed around the central portion, and the plurality of magnetic plates are separated from one another, and each of the plurality of magnetic plates comprises:
a magnetic plate main body;
a central post disposed on one side of the magnetic plate main body adjacent to the central portion, wherein the central posts of the plurality of magnetic plates are separated from each other;
a first outer post disposed on one side of the magnetic plate main body away from the central portion; and
a channel defined by a surface of the magnetic plate main body, the central post and the first outer post collaboratively and formed between the central post and the first outer post; and
a winding disposed in the channels of the plurality of magnetic plates.

2. The magnetic component according to claim 1, wherein the magnetic plate frame further comprises a magnetic plate frame main body and a plurality of holes, wherein the plurality of holes run through the magnetic plate frame main body and disposed around the central portion, wherein each of the plurality of magnetic plates covers corresponding one of the plurality of holes.

3. The magnetic component according to claim 2, wherein the magnetic plate frame further comprises a plurality of protrusions, each of the plurality of protrusions is protruded from a surface of the magnetic plate frame main body, each of the plurality of protrusion is located between corresponding two of the plurality of holes and comprises a recess, an opening of the recess faces away from the magnetic element, wherein at least portion of the winding is disposed in the recess, and at least portion of the winding is extended to the exterior of the magnetic component through the recess.

4. The magnetic component according to claim 3, wherein a height of each of the plurality of protrusions is equal to a height of the magnetic plate main body.

5. The magnetic component according to claim 3, wherein the magnetic plate frame further comprises a plurality of fixing portions, each of the plurality fixing portions is disposed on a surface of the magnetic plate frame main body, one side of each of the plurality of fixing portions is connected with the central portion and extended from the central portion toward the magnetic plate frame main body radially.

6. The magnetic component according to claim 5, wherein the magnetic plate frame further comprises a plurality of second outer posts disposed around a periphery of the magnetic plate frame main body, a gap is formed between two adjacent second outer posts, wherein each of the plurality of second outer posts, adjacent one of the plurality of protrusions, adjacent one of the plurality of fixing portion, a portion of the magnetic plate frame main body form a magnetic plate frame groove, wherein each of the plurality of magnetic plate is disposed on the magnetic plate frame groove.

7. The magnetic component according to claim 6, wherein a height of each of the plurality of second outer posts is equal to a height of the magnetic plate main body of the magnetic plate.

8. The magnetic component according to claim 1, wherein the first outer post of each of the plurality of magnetic plate is disposed around a periphery of the magnetic plate main body, each of the plurality of magnetic plates further comprises a mounting slot disposed on the periphery of the magnetic plate main body for receiving at least portion of the winding, and at least portion of the winding is extended to the exterior of the magnetic component through the mounting slot.

9. The magnetic component according to claim 1, wherein a height of the first outer post of each of the plurality of magnetic plates is equal to a thickness of the winding.

10. The magnetic component according to claim 1, wherein the central post of each of the plurality of magnetic plates is a sector-ring structure and comprises an inner ring portion and an outer ring portion, the inner ring portion is concaved from a side of the central post adjacent to the central portion, and the outer ring portion is disposed between the inner ring portion and the first outer post.
